(19) United States
(12) Patent Application Publication
(10) Pub. No.: US 2007/0011033 A1
(43) Pub. Date: Jan. 11, 2007

(54) SYSTEM AND PROCESS FOR PROVIDING INSURANCE

(76) Inventors: Paul Atkinson, Poway, CA (US); Ronald S. Conero, San Diego, CA (US); Charles A. White, Oakland, CA (US)

Correspondence Address: WILLIAM J. KOLEGRAFF, 3119 TURNBERRY WAY, JAMUL, CA, 91935, US

(21) Appl. No.: 11/456,811

(22) Filed: Jul. 11, 2006

Related U.S. Application Data
(60) Provisional application No. 60/698,407, filed on Jul. 11, 2005.
(60) Provisional application No. 60/699,945, filed on Jul. 14, 2005.

(51) Int. Cl. G06Q 40/00

(52) U.S. Cl. 705/4

(57) ABSTRACT

Automated insurance products, services, and processes are enabled by the more complete, timely, and accurate information provided by a conditional access network. Automated insurance processes are able to receive timely product information, such as product status and location, and adapt insurance policies or coverage responsive to the information. For example, an insurance policy may be adapted according to product activations, products that are deactivated, or according to which distributor is holding product. Information from the conditional access network may also be used to evaluate policy claims. For example, the insurance provider can use information from the conditional access network to confirm specific item coverage, to determine if products moved through authorized distributors, and to make sure they do not pay claims for items actually sold and activated. In this way, the insurance provider in enable to make more accurate and timely claim payments.

### RELATED APPLICATIONS

This application claims priority to U.S. patent application No. 60/698,407, filed Jul. 11, 2005, and entitled “Conditional Access Network for Providing Insurance”; and to U.S. patent application No. 60/699,945, filed Jul. 14, 2005, and entitled “Conditional Access Network for Providing Insurance”; both of which are incorporated herein in their entirety.

### BACKGROUND

1. Field

The present invention relates computer processes for providing insurance. More particularly, the invention relates to automated processes that adaptively provide information for delivering insurance products.

2. Description of Related Art

Providing insurance, is by its nature, a risky business. In the insurance business, better information, and more timely information, leads to better insurance products. There are many types of insurance products that protect trading parties against losses that result from theft or misappropriation of goods as they traverse a multi-party supply chain. Credit insurance, for example, protects against the loss resulting from the inability to collect accounts due to insolvency or unwillingness or inability to pay. Supply contract bonds guarantee faithful performance under a contract to supply goods and services, and cargo insurance provides warehouse to warehouse coverage for goods in transit. Business floater policies include consignment and sales floaters, which are policies that are sold to manufacturers and wholesalers to protect them from losses of property that is sold through consignment with another party.

Premiums for such insurance products are priced based on the perceived risk of providing the coverage. A component of this risk is the possibility of loss and theft of the products associated with an insurance policy, and the value of the covered products. Unfortunately, information for such multi-party trading models is typically incomplete, and often not timely, so risk decisions are made based on assumptions, historical averages, and guesswork. For example, the quantity of product in the supply chain is an ever-moving number. Products are continually added, products are sold, products are returned, and some products are lost or stolen. Without visibility the current inventory status, an insurance provider may be over or under covering based on actual numbers. Accordingly, there is needed an insurance system that can accurately and automatically adapt insurance products according to more current and more complete product information.

### SUMMARY

Briefly, the present invention provides new automated insurance products, services, and processes, which are enabled by the more complete, timely, and accurate information provided by a conditional access network. Automated insurance processes are able to receive timely product information, such as product status and location, and adapt insurance policies or coverage responsive to the information. For example, an insurance policy may be adapted according to product activations, products that are deactivated, or according to which distributor is holding product. Information from the conditional access network may also be used to evaluate policy claims. For example, the insurance provider can use information from the conditional access network to confirm specific item coverage, to determine if products moved through authorized distributors, and to make sure they do not pay claims for items actually sold and activated. In this way, the insurance provider in enable to make more accurate and timely claim payments.

The present invention generally relates to devices, networks, methods, procedures, products and business models for providing insurance products and services. Such products and services make use of the ability of a processor or other device associated with a target to provide authorized parties with conditional access to the target and to deny access to a target by unauthorized parties. Further, the process, upon authorized command, is able to permanently disable a product from future use. Since the network can securely and selectively activate or disable each insured product, an insurance company can better assess risk, and thereby set policy rates adapted to the specific product distribution condition. Also, the network may provide timely information on the condition of the products in the distribution chain, so that the insurance policy can be adapted to current distribution conditions.

Insurance can be provided according to the present methods by evaluating the risk associated with a conditionally accessible target or activity of a potential client. Among the factors which can be evaluated are the rate of loss associated with an activated target, the timeliness of the information about target sales and returns provided by a conditional access network, or the credibility of such information. As described below, a conditional access network using the embedded processors described herein can provide accurate and secure information concerning whether a target in the network is activated or deactivated, and whether such activation or deactivation is permanent (due to the disablement of an embedded processor's ability to change the activation state of a target). A price for the insurance product or policy evaluated in this way can be established based on the volume of targets in the supply chain, for example, and the product can be offered to a potential client (i.e., the beneficiary of the insurance). The insurance product can be, for example, credit insurance, consignment insurance, or a supply bond.

Potential clients for such an insurance product can be identified as a result of their participation in a conditional access network. Such participation can be validated through a system connection with the conditional access network. The potential client can also solicit the insurance product through the conditional access network. In one embodiment, the amount of risk or the policy value of an insurance product is adapted based upon authenticated events or information derived from authenticated events associated with the targets that are the subject of the insurance policy or product. Such information on authenticated events can be retrieved by the insurance provider or by the beneficiary of the insurance product in near-real time or in periodic batches.

### BRIEF DESCRIPTION OF DRAWINGS

These and other features, aspects and advantages of the present invention will become better understood with regard to the following description, appended claims, and accompanying figures where:

FIG. 1 is a flowchart of a system for providing insurance in accordance with the present invention.

FIG. 2 is a block diagram of a network system for providing information to support insurance products in accordance with the present invention.

FIG. 3 is a flowchart of a process for providing insurance in accordance with the present invention.

FIG. 4 is a flowchart of a process for providing insurance in accordance with the present invention.

FIG. 5 is a flowchart of a process for making claim payments for insurance in accordance with the present invention.

FIG. 6 is a flowchart of a process for adaptively providing insurance in accordance with the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

The ability to deny access to a feature of a target and to securely enable an authorized and authenticated party access to such feature can broaden the range of possible distribution channels for a product, and thereby increase sales opportunities. In particular, it enables the creation of new types of insurance products that are tailored to reflect the enhanced information available about targets that participate in a conditional access network.

There are many types of insurance products that protect trading parties against losses that result from theft or misappropriation of goods as they traverse a multi-party supply chain. Credit insurance, for example, protects against the loss resulting from the inability to collect accounts due to insolvency or unwillingness or inability to pay. Supply contract bonds guarantee faithful performance under a contract to supply goods and services, and cargo insurance provides warehouse to warehouse coverage for goods in transit. Business floater policies include consignment and sales floaters, which are policies that are sold to manufacturers and wholesalers to protect them from losses of property that is sold through consignment with another party.

Premiums for such insurance products are priced based on the perceived risk of providing the coverage. A component of this risk is the possibility of loss and theft of the products (i.e., targets) associated with an insurance policy. It is possible to provide an enhanced insurance product or policy for targets that participate in a conditional access network.

Insurance can be issued to manufacturers or wholesalers that participate in a conditional access network. Initially, the potential insurance beneficiary is determined to be a participant in a conditional access network. This can be validated through a network connection to a conditional access network. Once this is determined, the targets to be sold are verified to be manageable through such a network. The targets, or products, have an attached or integral embedded processor (EP) or other integrated circuit. This embedded processor may be scanned and read by authorized parties in the distribution chain, and the information verified and used by the conditional access network. Preferably, the communication from the reader to the embedded processor is an RF communication. With the parties and products confirmed to be on the conditional access network, the appropriate premium and amount of insurance for a given policy associated with the targets can be established. Determining factors for arriving at the premium amount can include the volume (absolute quantity or quantity over a defined period of time) of conditionally accessed targets to be sold; the level of historical or prospective risk associated with this target, this type of target, or other types of targets when they participate in a conditional access network; and the accuracy and timeliness of information about the distribution and sale of targets when they participate in a conditional access network.

The amount of outstanding insurance for targets can also be dynamically adjusted to reflect the volume of targets outstanding in the supply chain (remaining to be manufactured, shipped, or sold) when such targets participate in a conditional access network. As a new target is made or distributed, the amount of insurance can be dynamically increased. As return transactions occur involving such targets, the amount of outstanding coverage can likewise be increased. As targets are activated and sold, or when they are permanently deactivated (and thereby rendered valueless or reduced in value), the amount of insurance can be dynamically reduced. The dynamic aspects of this process are particularly significant in the case of consignment insurance.

As products (or targets) move through the distribution chain, the status of the products change according to authenticated transactions on the conditional access network. For example, the products may be shipped from the manufacturer in a disabled state, may be disabled through the entire distribution chain, and then be activated at a point of sale location. In another example, the products may be shipped from the manufacturer in a disabled state, and may be permanently disabled by a authorized distribution party if the product was defective, for example. As the status of the product changes, the value for the product also changes, which affects the insurance required to adequately protect the product. In this regard, the aggregate value of the insured products may be readily determined by assessing the status for all the covered products.

Bills from an insurance carrier can be generated based on information obtained from the conditional access network. In addition, payments from a beneficiary to the insurance carrier can be handled directly through the conditional access network, such as through a NOC, or can alternatively be made on the beneficiary's behalf by a third party using information obtained from the conditional access network. The amount of such payments, which are generally made on a periodic basis, can be varied according to a pre-determined formula or arrangement based on information obtained from the conditional access network concerning the targets.

This system can also support dynamic application for insurance by participants in the conditional access network. One or more insurers can establish a relationship with a conditional access provider. The potential insurance client can access the insurers through the network. The conditional access provider forwards the information that it has concerning the client and targets under the client's control to the insurance provider. The insurance provider can then respond through the conditional access provider connection or directly to the potential client.

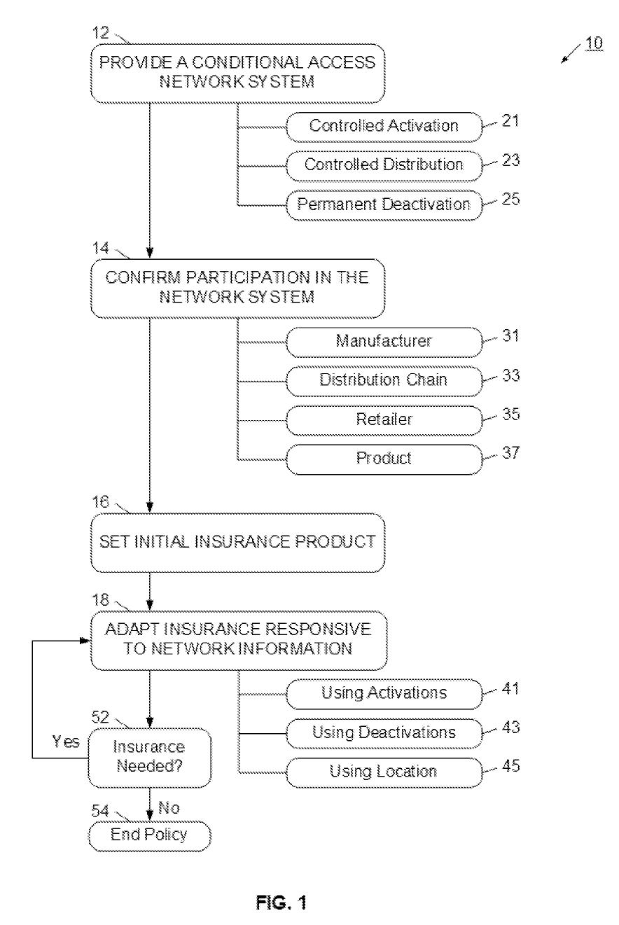

Referring now to FIG. 1, a method 10 for providing insurance is illustrated. Method 10 uses information obtained from a conditional access network, which enables a more refined and accurate approach to assess risk, and therefore, for pricing and providing insurance. Method 10 advantageously enables both the provider and beneficiary of insurance services to be more informed, and to better manage insurance issues. For example, with more complete and timely information regarding policy pricing, beneficiaries can adjust behaviors and processes to obtain better-valued insurance products. However, prior to fully describing method 10, it may be useful to generally describe the radio frequency integrated circuit, and the conditional access network in which it operates.

### DESCRIPTION OF THE NETWORK SYSTEM

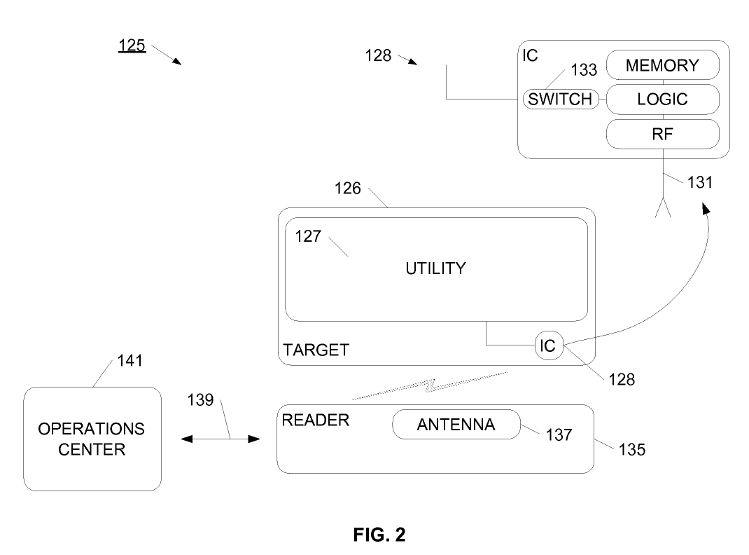

The insurance system 10 described with reference to FIG. 1 has been described as operating on a conditional access network system. Referring now to FIG. 2, an example of such a conditional access network system is illustrated. System 125 may operate, for example, in a retail environment, or may be part of a home based activation system. System 125 has target 126, which may be, for example, an optical disc such as a DVD, CD, gaming disc, HD DVD, or Blu-Ray DVD; the target may be an electronic device such as a portable music player, shaver, or drill; or the target may be a passport, driver's license, coupon, or other non-electronic good. It will be understood that target 126 may take other electronic or non-electronic forms. Target 126 has a utility 127, which is typically the primary usefulness for the target device. For example, if target 126 is a portable music player, then utility 127 is the ability to play music files. In another example, if target 126 is a DVD, then its primary utility 127 is to be read by an associated DVD player for presenting a movie or audio file to a user. Typically, utility 127 is the reason consumers are motivated to purchase or otherwise obtain target 126. Stated differently, if utility 127 were unavailable, and target 126 is not an attractive good for the consumer. In a similar way, the target would be unattractive for a thief or shoplifter. Further, by controlling a consumer's access to the utility of a product, a manufacturer is enabled to manage the rights to use the product. In this way, the manufacturer may set the conditions under which a consumer is able to use the physical product, and can even make the product forever unusable, thereby removing it from the stream of commerce. Importantly, this is all managed through a central network operations center, so does not require that the physical goods be returned to the manufacturer to be disabled.

Target 126 has a radio frequency integrated circuit 128. The integrated circuit 128 may be, for example, a tag attached to target 126, or may be integrally formed with other target circuitry or structures. Integrated circuit 128 couples to utility 127, and may selectively activate or deactivate the utility for target 126. For example, a DVD may initially be set such that it is unplayable in most DVD players, but upon an authorized sale, may have its utility activated. In this way, the DVD is unattractive to a thief or shoplifter while the DVD is in the distribution chain, but may be advantageously used by an authorized consumer. In another example, an electronic device has its power circuit disabled at the time of manufacture. The electronic device may then be moved through the distribution chain with a substantially reduced threat of theft. Since the electronic device would be unusable by any potential thief or shoplifter, it is far less likely that anyone will steal or otherwise misappropriate the device. However, at the point-of-sale and upon consummation of an authorized transaction, the power circuit for the electronic device may be activated. In this way, the authorized consumer may normally use the electronic device for its intended purpose.

An enlarged view of integrated circuit 128 shows that integrated circuit 128 has a memory, logic, and a radio frequency portion coupled to antenna 131. Upon receiving appropriate codes or commands via antenna 131, the integrated circuit may cause switch 133 to change states. More particularly, the RF section may receive codes or commands that the logic compares to commands or codes stored in memory. If the received codes match codes secretly stored in memory, then the integrated circuit may determine that an authorized code has been received. This command may, for example, cause the utility 127 to activate, or may cause the utility 127 to deactivate. In one state, switch 133 causes the utility 127 to be unavailable, and in another state causes the utility 127 to be fully available. It will be appreciated that switch 133 may be constructed with more than two states. However, for ease of explanation, switch 133 will be described as having only a deactivated state and an activated state.

It will be understood that switch 133 may take several forms. For example, switch 133 may be an electrochromic material that changes optical characteristics responsive to the application of a voltage. In another example, switch 133 may be fuse, anti-fuse, or other circuit device that is capable of changing electronic states. In yet another example, switch 133 may be a memory logic state, or a circuit device that has a voltage that may be sensed and understood as a logic value. It will also be understood that in some cases switch 133 main be persistently transitioned from a first state to a second state, and in other cases switch 133 may be reversible.

At time of manufacture, IC 128 is typically set to disable utility 127 for target 126. In this way, target 126 is an unattractive theft target, as it is in an unusable or disabled state. At the point-of-sale, which may be a point-of-sale terminal in a retail establishment, a kiosk, or a home activation site, target 126 is placed proximate a reader 135. Reader 135 has an RF antenna 137 and RF transceiver for communicating with IC 128. When positioned proximate reader 135, IC 128 passes identifying information to reader 135, which then communicates the identifying information through a network connection 139 to an operations center 141. The operations center 141 generates or retrieves an activation or authorization code specific for target 126. The activation or authorization code is transmitted back to reader 135 and then communicated to target 126. Provided a proper code is received, the logic causes switch 133 to change state, and activate the utility 127 for target 126. In this way, the target has no or reduced utility through the distribution chain, but is efficiently activated at a point-of-sale.

Although the above description describes an activation process, in a more general case, the IC may be used to selectively make a range of functions available or unavailable, and may make some of these functions only temporarily available. In this sense, the IC and network processes are used to affect the utility of the target. The target with controllable utility may be an electronic device, or alternatively, may be a tangible media, such as an optical disc. The controlled target has a change effecting device that is set to a first state, which allows the target to operate according to a first utility. The controlled target also has a receiver for receiving an authorization key, and logic, which, responsive to the authorization key, selectively changes the change effecting device to a second state. When the change effecting device is in the second state, the target may operate according to a second utility. In one example, the controlled target has a restricted access key that was stored during manufacture, and the restricted access key is used by the logic in changing the state of the change effecting device. To change the utility of the controlled target, the controlled target is placed proximate to an activation device. The activation device may read an accessible identifier from the controlled target, and retrieve or generate an authorization key that is associated with the target. The activation device may cooperate with a network operation center or other entity to retrieve the authorization key, and to obtain approval to change the utility of the controlled target. If approved, the activation device may then send the authorization code to the controlled target.

A distribution control system is provided to support the controlled and selective changing of utility for a target. The target with controlled utility may be an electronic device, or alternatively, may be a tangible media, such as an optical disc. The distribution control system has a target with a change effecting device and a restricted access key. An activation device retrieves or generates an authorization key, and sends the authorization key to the target. The authorization key may be sent to the target wirelessly, for example, using a radio frequency signal. The target has logic that uses the restricted access key and the authorization key to change the utility of the target. In one example, the activation device retrieves the authorization key from a network operation center (NOC) by sending a target identifier to the NOC, and the NOC retrieves the authorization key for the identified target. The activation device may also connect to other systems for obtaining approval to change the utility of the target. For example, the authorization key may be sent to the target upon receiving payment, password, or other confirmation.

In a specific example of the distribution control system, a target is manufactured with a change effecting device set to compromise the utility of the target. In this way, the compromised target would be nearly useless to a thief, and therefore would be less likely to be a target of theft. The manufacturer has also stored an identifier and a restricted access key with the target. The manufacturer also stores the accessible identifier and its associated key for later retrieval by a party authorized to restore the utility to the target. In one example, the identifiers and keys are stored at a network operation center (NOC). The compromised target may be moved and transferred through the distribution chain with a substantially reduced threat of theft. When a consumer decides to purchase the target, the target is passed proximally to an activation device. Its accessible ID is read by activation device, and using a network connection to the NOC, sends the accessible ID. The NOC retrieves the authorization key for the target. Additional approvals may be obtained, for example, confirmation of payment, identification, password, or age. When approved, the activation device transmits the authorization key to the target, typically using a wireless communication. The target receives the authorization key, and using its logic, compares the authorization key to its stored restricted access key. If the keys match, then the target uses an activation power source to switch the state of the change effecting device. Then, the target will have full utility available to consumer.

The systems, processes, networks and devices for providing an RF activatable product are fully set out in the following U.S. Patent application, which is incorporated herein by reference as if set forth in its entirety:
1. U.S. patent application Ser. No. 11/295,867, filed Dec. 7, 2005, and entitled “Device and Method for Selectively Activating a Target”.

Referring again to FIG. 1, a system for providing insurance products is illustrated. System 10 operates on a conditional access network. Generally, the conditional access network system 12 allows products to be distributed through a distribution chain in a secured, authenticated, and controlled manner. More specifically, this means that the product may be disabled or deactivated at the time of manufacture, and then upon predefined conditions being met, may be activated as shown in block 21. Also, the conditional access network system allows for controlled and managed distribution of the product as shown in block 23. More specifically, the product may be monitored as it moves from entity to entity in the distribution chain, so that the location or holder of the product is known. With this information, the product's distribution path can be monitored, and the product can be restricted to only being handled by authorized distributors. The conditional access network system also allows for permanent deactivation of the product as shown in block 25. In this way, overstock merchandise, defective merchandise, recalled merchandise, or lost merchandise may be permanently deactivated upon presentation at a point-of-sale location. By providing for controlled activation of a product, controlled distribution of that product, and selective permanent deactivation of products, the conditional access network system enables more efficient and effective insurance products to be offered.

In offering insurance, an insurance provider would first confirm that all entities handling the product are participating in the network system. For example, the manufacturer 31 must be able to deactivate the product at the point of manufacture, and those in the distribution chain 33 should be able to scan the product upon receipt and delivery so that the precise location of the product may be tracked. Further, retailers 35 need to have the proper point-of-sale activation equipment to activate the products. Provided the manufacture, entities in the distribution chain, and the retailer all participate in the program, the insurance provider may be able to use the conditional access network system to offer improved insurance products. Of course, the insurance provider needs to confirm that all the products 37 are also selectively activatable and deactivatable in the network

Once the manufacturer has identified the entities in the distribution chain, including the manufacture and retailer, and has confirmed the specific products that will be participating in the insurance policy, the insurance provider is able to more effectively evaluate risk for providing insurance. This insurance may be, for example, consignment insurance, risk of loss insurance, credit insurance, or any other insurance product. Because the insurance provider has increased visibility to the status of each individual product, and because the product may be more accurately controlled through its distribution chain, it is likely that more cost-effective and valuable insurance products may be provided.

The insurance product may be automatically adapted responsive to current network information as shown in block 18. For example, the network system may be able to provide information to the insurance carrier showing when specific products have been activated as shown in block 41. In a similar way, the network system may be able to inform the insurance carrier when products have been permanently disabled as shown in block 43. In another example, the network system may be able to show the precise location of a specific product. Based upon this and other information, the insurance carrier may automatically adapt the coverage or cost of an insurance policy. For example, if products are moved to a location not acceptable to the carrier, the carrier may immediately drop those products from coverage. In another example, as products are activated or disabled, the cost of insurance may be timely reduced as fewer products are at risk. As long as products are in the distribution chain that need insurance as shown in block 52, the process may continue to automatically adapt the scope and price of the insurance policy. As soon as all products are activated or disabled or products have been used in a way that invalidates the policy, the policy will end as shown in block 54.

Advantageously, the insurance system 10 enables an insurance carrier to more fully assess risk for a particular product distribution process, and thereby offer more price competitive and valuable products to its clients. In a similar way, the beneficiaries of the insurance policies are able to better adjust business practices to control costs of insurance. For example, high risk distributors or high risk shipping companies may be avoided to reduce overall insurance costs. Also, by more precisely controlling the quantity of merchandise in the distribution chain, the number of products being covered by the insurance policy may be minimized.

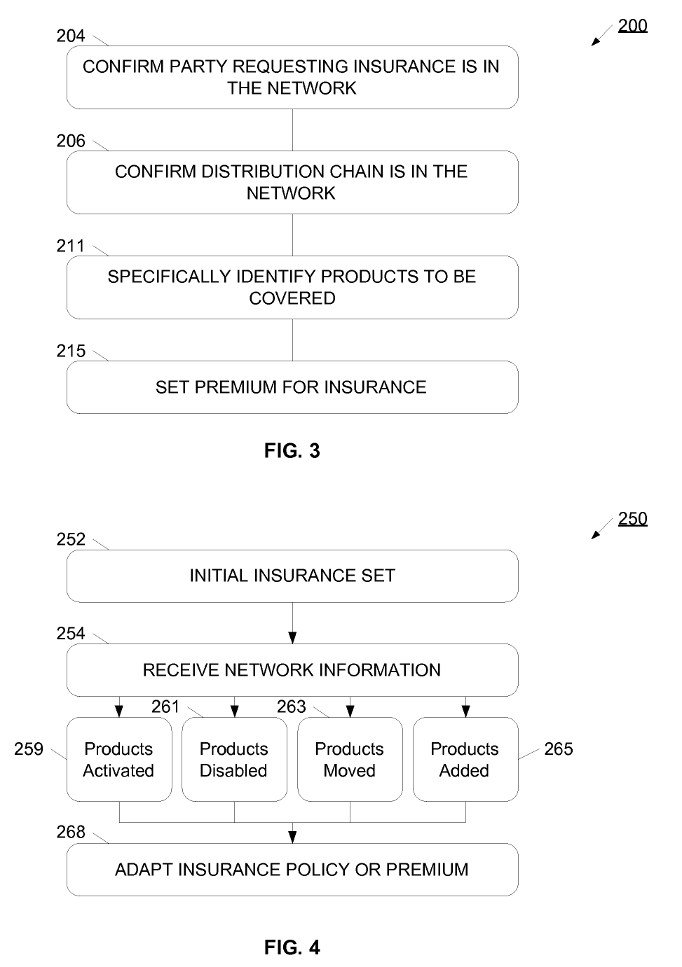

Referring now to FIG. 3, a general process for offering insurance is illustrated. Process 200 starts by having an insurance provider confirm that a party requesting insurance is on a conditional access network. The insurance carrier also confirms that each entity in the distribution chain is in the network as shown in block 206. This would include manufacturers, shippers, warehouses, other distributors, and the retailer. Of course, if one or more of the distribution entities is not in the network, insurance may still be offered, but policy coverage may be reduced or insurance premiums increased. The insurance carrier can also identify specifically the products to be covered as shown in block 211. More particularly, the insurance carrier can identify the product down to the item level. This is possible, for example, because each product has a unique integrated circuit device embedded or attached to it, which has an identification number unique to that individual product. In this way, the insurance carrier can provide insurance down to the item level, even for specific items such as DVDs, razors, drills, toys, or other relatively low-cost items. By enabling product coverage down to the item level, the insurance carrier is able to better assess risk, and may reduce false claims. Since the insurance carrier has far more information than typical with known insurance products, the insurance carrier is able to more precisely evaluate risk and set accurate pricing for the insurance policy as shown in block 215. Typically, because of the increased information, the insurance carrier is able to provide an insurance policy more adapted or tuned to the specific requirements of the requesting party. Further, since many of the factors used by the insurance carrier to set the premium are under the control of the requesting party, the requesting party may take the necessary actions to assist in reducing the premium cost.

Referring now to FIG. 4, another insurance product process 250 is illustrated. Process 250 starts with an initial policy having already been issued for a set of products in the distribution chain as shown in block 252. For example, this initial insurance policy may have been set according to the process defined in FIG. 3. It will also be understood that the initial insurance policy may be set in other ways. The insurance carrier receives information from the conditional access network as shown in block 254. This information may be received in a near real-time basis, or may be received periodically. This information received from the conditional access network may then be used to adapt the insurance policy or premium as shown in block 268. For example, the conditional network may inform the insurance carrier as products are activated as shown in block 259. The network may also inform the carrier as products are permanently disabled as shown in block 261, or as products are moved between distributors as shown in block 263. The conditional access network may also be able to inform the carrier as products are added into the overall distribution chain. Using this and other information, the insurance carrier may reassess risk or value of the covered products, and make near real-time or periodic adjustments to the insurance policy or premium. In this way, by providing current information on location and status of products in the distribution chain, a near real-time insurance product may be offered.

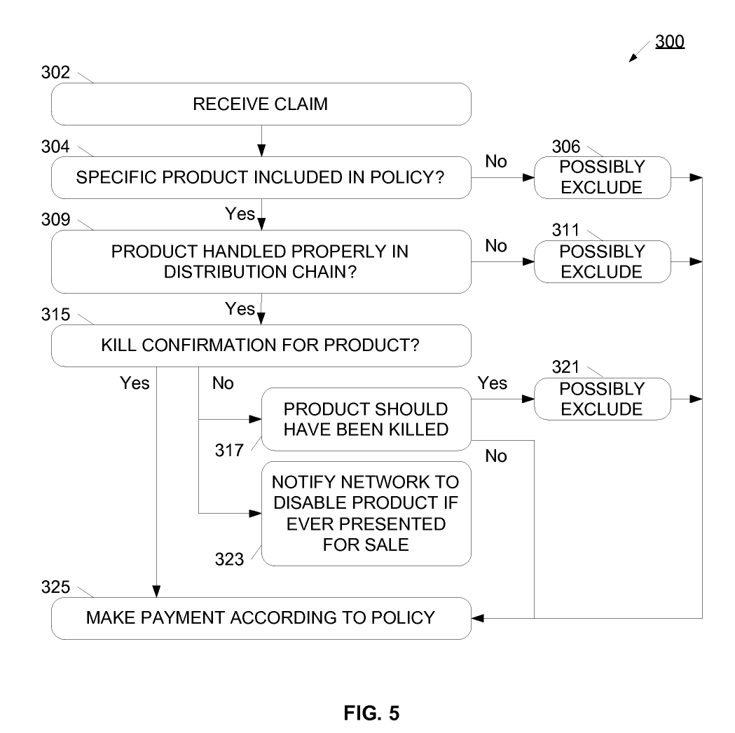

Referring now to FIG. 5, a process 300 for processing an insurance claim is illustrated. Process 300 starts with an insurance company receiving a claim as shown in block 302. Upon receiving a claim, the insurance carrier may confirm that the specific product is included in the policy as shown in block 304. More particularly, because each product in the conditional access network is individually identifiable, the insurance carrier can confirm that the product submitted for claim was covered by the insurance policy. In this way, fraud or mistake may be avoided. Those products that were not specifically covered may be excluded as shown in block 306. Provided the product was included in the policy, the insurance carrier has sufficient information to assess whether the product was handled properly in the distribution chain as shown in block 309. For example, the carrier may determine that an unauthorized shipper handled the product, and thereby voided the insurance policy. The insurance carrier could also find for example, that a product was shipped via air freight, when altitude sensitivities are known for the product. Since the product did not go through a proper distribution channel, the insurance carrier may possibly exclude that product as shown in block 311.

Provided the product was properly handled, then the insurance carrier can determine whether a kill confirmation has been received for that product as shown in block 315. As discussed herein, when a product is permanently disabled by the conditional access network, the product sends a final kill confirmation message back to the network. In this way, the network may confidently remove the product from the stream of commerce, and the product is never activatable. If no kill confirmation has been received for the product, then the insurance carrier may assess whether the product should have been killed as shown in block 317. Of course, there will be reasons why a product could not legitimately be killed, for example, if the products are lost in fire or accident. However, for products that should have been killed, the insurance carrier may be able to possibly exclude them as shown in block 321. For those products that should have been killed, the insurance carrier may notify the conditional access network that these products are to be removed from the commerce stream, and if ever presented for activation, will be killed instead.

For those products with a confirmed kill, the insurance carrier can make payment according to the policy as shown in block 325. The insurance carrier may also include products that generally did not have a confirmed kill confirmation, and those that were not excludable under policy conditions. By specifically controlling which products are covered, managing the distribution chain, and determining the kill status, an insurance carrier may more precisely pay claims, thereby reducing fraud or over/under payments. In a similar manner, policyholders who follow policy guidelines and act responsibly can assure that they are properly paid by having complete information for the insurance carrier.

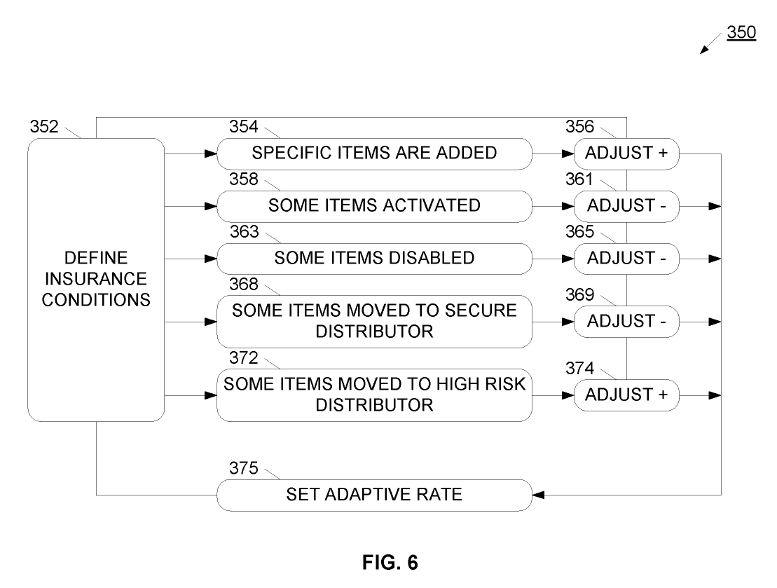

Referring now to FIG. 6, an automatically adaptable insurance product 350 is illustrated. Product 350 has a set of defined insurance conditions as shown in 352. For example, these defined insurance conditions may be a set of rules that are associated with product costs, location, and status. Accordingly, these rules may use information from the conditional access network to automatically set and adapt insurance coverage and cost. In this way, a near real-time insurance product is enabled. For example, the conditional access network may provide information as to when specific items are added to the stream of commerce as shown in block 354. This information is provided down to the item level, so that the insurance policies may be written to particularly identify the item being covered. As additional items are added to the stream of commerce, the cost and coverage of the insurance policy may be adjusted upward as shown in block 356.

The conditional access network may also provide timely information as to when some of the items are being activated as shown in block 358. As items are activated, they are removed from the stream of commerce and coverage is no longer needed, so the policy coverage or premiums may be adjusted downward as shown in block 361. In a similar manner, the conditional access network may provide information as to when products are permanently disabled as shown in block 363. As these parts are permanently disabled and removed from the stream of commerce, the insurance coverage or premium may be adjusted downward as shown in block 365. The insurance conditions 352 may contain rules according to the specific location of products. For example, as items are moved to more secure distributors as shown in block 368, the cost of the insurance may be adjusted downward as shown in block 369. However, as products are moved to more high risk distributors or locations as shown in block 372, the insurance cost may be adjust upward as shown in block 374. With these and other risk factors, the automated system may adaptively set an insurance rate as shown in 375.

Providing for Secure Activation

To provide the automated insurance processes, a supporting activation network provides a system for authenticating and securing product transactions. An integrated circuit is attached to a target, such as an optical disc or electronic device. The integrated circuit has an RF transceiver that is capable of establishing communication with an associated reading device. The integrated circuit also has a hidden memory, which can not be read externally, and a user memory. The hidden memory stores an authentication message, while the user memory stores readable authentication information. The hidden authentication message and the authentication information are related through a cryptographic process. However, even though the integrated circuit benefits from the cryptographic security, the integrated circuit only operates relatively simple logic operations. In this way, a highly secure transaction is enabled without requiring significant processing power or time at the integrated circuit. When the integrated circuit is placed near the reader, the reader reads the authentication information, and with the cooperation of a network operation center, uses the authentication information to derive an activation code. The reader passes the activation code to the integrated circuit, which compares the activation code to its hidden activation message. If they have a proper relationship, the communication has been authenticated, and the integrated circuit proceeds to perform an action.

In one example, a random plaintext number is stored as the hidden authentication message, and the user memory has authentication information that includes an identifier, as well as an encrypted version of the plaintext number. When the integrated circuit is placed near a reader, the reader reads the authentication information, which is sent to a network operation center. The network operation center uses the identification information to retrieve a decryption key, and uses the key to decrypt the encrypted message to derive the plaintext number. The plaintext number is sent to the reader, which communicates it to the integrated circuit. The integrated circuit does a simple logical compare between the received number and the hidden number, and if they match, the integrated circuit proceeds to perform an action. The action may be, for example, activating or deactivating the product the circuit is attached to. The hidden authentication message and the authentication information are related through a cryptographic process. In this example, the integrated circuit benefits from the cryptographic security, even though the integrated circuit only operates a relatively simple logic operation. In this way, a highly secure transaction is enabled without requiring significant processing power or time at the integrated circuit.

In another example, an authentication code is stored as the hidden authentication message, and the user memory has authentication information that includes identifiers, as well as a public key that can be used to recreate the authentication code. When the integrated circuit is placed near a reader, the reader reads the authentication information, which is sent to a network operation center. The network operation center uses the identification information to retrieve a private key, and uses the public key, private key and other authentication information generate the authentication code. The authentication code is sent to the reader, which communicates it to the integrated circuit. The integrated circuit does a simple logical compare between the received code and the hidden code, and if they match, the integrated circuit proceeds to perform an action. The action may be, for example, activating or deactivating the product it is attached to. The hidden authentication message and the authentication information are related through a cryptographic process. In this example, the integrated circuit benefits from the cryptographic security, even though the integrated circuit only operates a relatively simple logic operation. In this way, a highly secure transaction is enabled without requiring significant processing power or time at the integrated circuit.

In yet another example, the present invention discloses a cryptographic process. Two pairs of public/private keys are generated in such a way that a combination of the first private key and the second public key is equivalent to the combination of the first public key with the second private key. The key combinations, when combined with additional meaningful information, produce a limited set of authentication messages. The process provides a highly secure method of authentication requiring minimal computation and power at the embedded processor.

Advantageously, the conditional access network enables a highly secure and authenticated transaction, even when the authorizing circuit is operating in a low-power, low processing capability environment. This means that an RFID tag or other RF-enabled integrated circuit may be used to communicate sensitive information, and become an integral part of a secure transaction process. This enables an RF-enabled circuit to perform secured actions, thereby allowing manufacturers to enforce distribution and use rules

The systems, processes, and devices for providing a secure activation network are fully set out in the following U.S. Patent applications, all of which are incorporated herein by reference as if set forth in their entirety:
1. U.S. patent application Ser. No. 11/456,037, filed Jul. 6, 2006, and entitled “Device and System for Authenticating and Securing Transactions Using RF Communication”;
2. U.S. patent application Ser. No. 11/456,040, filed Jul. 6, 2006, and entitled “Method for Authenticating and Securing Transactions Using RF Communication”;
3. U.S. patent application Ser. No. 11/456,043, filed Jul. 6, 2006, and entitled “Device and Method for Authenticating and Securing Transactions Using RF Communication:” and
4. U.S. patent application Ser. No. 11/456,046, filed Jul. 6, 2006, and entitled “System and Method for Loading an Embedded Device to Authenticate and Secure Transactions.
   Providing for Permanent Deactivation

To provide the automated insurance processes, supporting deactivation devices and process are used. The deactivation systems have an integrated circuit device attached to a target. In one example, the integrated circuit device is a tag attached to or integrated with a product such as an electronic device or optical disc. In another example, the integrated circuit device may be integrated into the product's circuitry. The integrated circuit is controllable to effect an action at the target, such as activating or deactivating the usefulness of the product. The integrated circuit has a logic and memory section connected to an antenna for receiving communications from an associated reader or scanner. The integrated circuit also has a component constructed to transition from a first state to a permanent second state. For example, the component may be a fuse, a partial fuse, or an anti-fuse. The integrated circuit also stores a hidden secret kill code, and upon receiving a matching kill code from the reader, permanently transitions the component to its second state. When the component is in the permanent second state, the integrated circuit is incapable of effecting the action on the target. In this way, the integrated circuits ability to affect the target may be permanently disabled. The integrated circuit may also verify its function is disabled, and report a kill confirmation to the reader.

In one example, the integrated circuit is attached to an optical disc such as a DVD. The integrated circuit couples to an RF antenna for receiving data and power. The integrated circuit also has output ports connected to an electrochromic device, with the electrochromic device positioned over some important data on the disc. The optical disc is initially shipped with the electrochromic material in a darkened state, such that the DVD will not operate in an associated DVD player. If properly authorized, the integrated circuit is capable of transitioning the electrochromic material to a relatively transparent state, such that it activates the usefulness of the DVD so that it may be played. However, in some cases it may be desirable to cause the DVD to be permanently unplayable by disabling the ability of the integrated circuit to effect a change in the electrochromic material. Accordingly, the integrated circuit has a secret kill code in a write-once memory location. Upon receiving a matching kill code through the RF communication path, the integrated circuit causes a component to permanently transition to a second state. This component may be, for example, a fuse, a partial fuse, an anti-fuse, or a logic state. Upon transitioning the component, the integrated circuit is incapable of transitioning the electrochromic material to its transparent state. In this way, integrated circuit has been disabled from ever activating the DVD disc. The integrated circuit may also verify its ability to activate the disc is disabled, and report a kill confirmation to the reader. In this way, the retailer and manufacturer may be confident that the DVD has been permanently removed from the stream of commerce.

Advantageously, the kill process confidently and controllably allows products to be permanently disabled. In this way, manufacturers are enabled to more fully control the distribution of their products, and be assured that specific goods have been removed from the stream of commerce.

The systems, processes, and devices for permanently disabling the target from being activated are fully set out in the following U.S. Patent application, which is incorporated herein by reference as if set forth in its entirety:
1. U.S. patent application Ser. No. 11/456,680, filed Jul. 11, 2006, and entitled “A Radio Frequency Activated Integrated Circuit and method of Disabling the Same”.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An automated process for providing insurance for targets, the automated process operating on a general purpose computer system, comprising:
receiving electronic messages from a conditional access network, the messages selected from the group consisting of: target activation message, target kill-confirmation message, target movement message, and additional deactivated targets added message; and
adapting an insurance policy responsive to the received messages.

2. The automated process according to claim 1, wherein the step of adapting the insurance policy comprises calculating the value of remaining targets after removing value associated with activated and killed targets.

3. The automated process according to claim 1, wherein the step of adapting the insurance policy comprises adjusting a price for the insurance.

4. The automated process according to claim 1, wherein the step of adapting the insurance policy comprises adjusting a non-price term of the insurance.

5. The automated process according to claim 1, wherein the adapting step comprises adding the additional deactivated products as covered products under the insurance policy.

6. The automated process according to claim 5, further including increasing a price for the insurance responsive to adding the additional deactivated products.

7. The automated process according to claim 1, wherein the adapting step comprises removing some products as covered products responsive to receiving one of the messages.

8. The automated process according to claim 1, wherein the adapting step comprises reducing coverage responsive to activation messages and kill messages.

9. The automated process according to claim 1, wherein the adapting step comprises changing insurance terms responsive to the product movement message.

10. The automated process according to claim 1, wherein the adapting step comprises using a set of rules and the received messages to adapt the insurance policy.

11. A process for providing insurance for products, comprising:
confirming the manufacturer of the products uses a conditional access network to disable the products;
confirming distribution entities for the products use a conditional access network to track the products;
confirming retail entities for the products use a conditional access network to activate the products;
receiving location and activation information from the conditional access network; and
adapting the insurance according to the received information.

12. The process according to claim 11, wherein the receiving step comprises receiving automated messages from the conditional access network.

13. The process according to claim 12, wherein the adapting step comprises using computerized algorithms to adapt the insurance according to the received automated messages.

14. The process according to claim 11, wherein the adapting step comprises using computerized algorithms to adapt the insurance.

15. A process for paying an insurance claim, comprising:
receiving a claim to pay for products covered by an insurance policy;
receiving identification numbers from a conditional access network, the identification numbers usable to confirm that specific items in the products are covered by the insurance claim;
receiving distributor information from the conditional access network, the distributor information usable to determine if the products were handled only by authorized distributors;
receiving activation information from a conditional access network, the activation information usable to determine if the products can be excluded from payment;
making a claim payment for products with covered identification numbers, that were handled properly, and are not activated.

16. The process for paying an insurance claim according to claim 15, further including the step of receiving kill information from a conditional access network, and comparing the killed products to the covered products.

17. The process for paying an insurance claim according to claim 11, further including the step of sending a kill message to the conditional access network, the kill message identifying products fro which a claim was paid, but that were no included in the kill information.

18. An automated insurance product, comprising:
a risk of loss determined in response to:
messages indicating status of targets; and
messages indicating location of the targets.

19. The automated insurance product according to claim 18, wherein the messages are received from a conditional access network.

20. The automated insurance product according to claim 18, further including adapting the risk of loss from time to time in response to additional messages indicating status and additional messages indication location.

21. The automated insurance product according to claim 20, wherein the risk of loss is adapted in near-real time.

22. The automated insurance product according to claim 20, wherein the risk of loss is adapted periodically.

23. The automated insurance product according to claim 20, wherein the risk of loss is adapted hourly, daily, weekly, or monthly.

24. The automated insurance product according to claim 18, further including automatically adjusting billing according to the determined risk of loss.

25. The automated insurance product according to claim 18, wherein the scope of coverage is defined by:
adding new targets according to receiving messages indicating additional deactivated targets;
reducing according to receiving messages indicating a covered target has been activated; and
reducing according to receiving messages indicating a covered target has been permanently disabled.

26. The automated insurance product according to claim 18, wherein the messages received indicating status are kill-confirmation messages or activation messages.

27. The automated insurance product according to claim 18, wherein the messages received indicating location are messages confirming which distribution party has control of the respective target.
